(19) United States
(12) Patent Application Publication
(10) Pub. No.: US 2025/0243037 A1
(43) Pub. Date: Jul. 31, 2025

(54) Electrical Connector

(71) Applicant: Dinacell Electrónica, S.L., Rivas-Vaciamadrid (Madrid) (ES)

(72) Inventor: Gerardo Muñoz González, Rivas-Vaciamadrid (Madrid) (ES)

(21) Appl. No.: 18/854,340

(22) PCT Filed: Apr. 6, 2022
(86) PCT No.: PCT/ES2022/070207

§ 371 Date: Oct. 4, 2024

(51) Int. Cl. B66B 7/12; B66B 5/00; B66B 7/06; H01R 12/77; H01R 13/40; H01R 13/506; H01R 13/512

(52) U.S. Cl. CPC B66B 7/1223; B66B 5/0025; B66B 5/0087; B66B 7/062; H01R 12/777; H01R 13/40; H01R 13/506; H01R 13/512

(57) ABSTRACT

The present invention belongs to the technical field of electrical connectors, particularly to technical connectors for drive belts or tensioning belts of lifts. The present invention relates to an electrical connector, as well as to an electrical connection system. In a particular embodiment, the present invention is used in the sector of lifts and/or elevators, both for people and loads.

Likewise, the present invention relates to the method for assembling said electrical connection system, as well as to a method for measuring the wear and/or breakage of a drive belt.

### CROSS-REFERENCE TO RELATED APPLICATIONS

This application is the United States national phase of International Application No. PCT/ES2022/070207, filed Apr. 6, 2022, the disclosure of which is hereby incorporated by reference in its entirety.

### BACKGROUND OF THE INVENTION

### Field of the Invention

The present disclosure belongs to the technical field of electrical connectors, particularly to technical connectors for drive belts or tensioning belts of lifts. The present disclosure relates to an electrical connector, as well as to an electrical connection system. In a particular embodiment, the present disclosure is used in the sector of lifts and/or elevators, both for people and loads.

Likewise, the present disclosure relates to the method for assembling said electrical connection system, as well as to a method for measuring the wear and/or breakage of a drive belt.

### Description of Related Art

Today, the field of technology of technical connectors for drive belts includes known examples of connectors which allow electrical contact between the metallic cables embedded in said drive belt or bearing strap.

Bearing straps are formed by twisted cables made of metallic wires, usually steel wires, which constitute bearing elements or cables, said bearing elements being embedded in a plastic matrix, particularly a polymer matrix. The twisted cables are arranged in parallel and the plastic matrix is fundamentally used to protect against the environment, to maintain the distances between the cables, and to reduce the friction of said twisted cables with other external elements, pulleys, and other mechanisms of the machines. Bearing straps thus configured are therefore in the form of a flat, elongated belt comprising therein parallel metallic cables having essentially rectilinear paths. Although bearing elements with such construction offer advantages in terms of flexibility with respect to conventional drive cables, their plastic matrix-based configuration entails problems because it hinders or prevents the visual inspection of the metallic cables housed therein since it is an opaque material.

In the current state of the art, there are several methods for inspecting the state of bearing cables in a configuration such as the one mentioned above, with most of said methods being based on the change in the electrical properties of the bearing cables which occurs as the cables experience normal wear or anticipated deterioration, which requires direct access to said bearing cables.

In that sense, in order to access the inside of the bearing strap, thereby having direct access to the bearing cables housed therein, current electrical connectors have piercing elements which, by means of force, go through the plastic material of the drive belt until they contact the metallic cables transversely.

Therefore, the piercing elements must have sufficient length in order to be able to go through the entire layer of plastic material, and to thereby contact the metallic cables on the inside. In turn, these piercing elements must also have a sharp end which can be introduced in the plastic material and completely go through same until it reaches the metallic cables.

This requires a compromise, given that the piercing elements, in the case of being extremely fine to facilitate their access into the drive belt, may undergo deformation and have a diverted path. In other cases, if said piercing elements are fragile, the application force required to obtain the suitable path to the metallic cables may cause them to break.

Moreover, in the case of robust piercing elements, insertion into the plastic material is more complicated, where the resistance exerted by the plastic material may be higher than the force applied when inserting the piercing elements, thereby requiring additional force to achieve contact.

Document US 2011/220438 A1 discloses a load supporting belt for a transport device.

Document US 2016/0221796 A1 relates to a rope terminal arrangement, an arrangement for condition monitoring of an elevator rope and an elevator.

Document US 2021/0331897 A1 discloses a belt end termination for a belt comprising a plurality of load carriers.

### SUMMARY OF THE INVENTION

The present disclosure relates to an electrical connector for a drive belt which in an operative mode allows electrical connection with the metallic cables embedded in the plastic material of the drive belt.

Additionally, the present disclosure also relates to an electrical connection system, as well as to a method for assembling an electrical connection system.

Lastly, the present disclosure also relates to a method for measuring the wear and/or breakage of a drive belt.

The first inventive aspect relates to an electrical connector for a drive belt, comprising:
a main body extending according to a longitudinal direction X-X′, wherein the main body comprises:
   an inner housing,
   a first end, and
   a second end comprising an opening which allows accessing the inner housing,
contact means housed in the inner housing, oriented according to the longitudinal direction X-X′ towards the second end.

Advantageously, the main body of the connector allows the contact means to be housed in a device which allows the protection thereof, said main body being a rigid element.

The opening present at the second end of the main body allows accessing the inner housing, and therefore accessing the contact means. In a particular embodiment, the opening has a rectangular section adapted for housing the section of a drive belt.

In a particular embodiment, the contact means comprise a plurality of protrusions, said protrusions being oriented towards the second end, and therefore, towards the opening of the second end.

In a particular embodiment, at least one of the plurality of protrusions comprises a sharp end configured for perforating or going through an external element.

In a particular embodiment, at least one of the plurality of protrusions comprises a flat end configured for contacting a flat surface of an external element.

In a particular embodiment, the contact means are arranged at a point of the inner housing of the main body adjacent to the opening of the second end.

In a particular embodiment, the main body is configured by at least two parts, said at least two parts being attached to one another, preferably by means of snap-fitting and/or a screwed attachment and/or a riveted attachment.

In a particular embodiment, at least one portion of the main body is manufactured from an insulating material, for example, plastic, resins, etc. Advantageously, this allows insulating any electrical connection established therein.

In a particular embodiment, the electrical connector further comprises electrical connection means connected to the contact means, and said electrical connection means being configured for connecting the contact means to external equipment, preferably through at least one connection cable. In other words, when in use, the present electrical connector advantageously allows an electrical connection to be established from the contact means to a piece of external equipment through at least one metallic cable.

In a particular embodiment, the electrical connection means are metallic elements and are in direct contact with the contact means. The electrical connection means preferably comprise metallic elements, as well as pins and/or pass-through elements which go through the metallic elements of said electrical connection means and are housed in the contact means, thereby allowing direct contact between these metallic elements and the contact means.

In a particular embodiment, the electrical connector further comprises actuation means configured for actuating the contact means, said actuation means being housed in the inner housing and oriented according to the longitudinal direction X-X′.

The actuation means and the contact means are therefore positioned adjacent and in contact with one another. In other words, the actuation means act, according to this configuration, as a push platform for the contact means, with the positioning of said contact means thereby being advantageously improved.

In a particular embodiment, the actuation means comprise at least one projecting element in contact with the contact means. In a particular embodiment, the at least one projecting element of the actuation means is partially housed at one end of the contact means.

The actuation means are housed in the inner housing of the main body of the electrical connector. In a particular embodiment, the actuation means are supported on one end of the inner housing by means of one of the ends thereof, with the opposite end comprising at least one projecting element in direct contact with the contact means. The attachment of the actuation means and the contact means are therefore oriented according to the longitudinal direction X-X′ towards the opening of the second end, with the contact means therefore being arranged in a position closer to said opening in the inner housing of the main body.

In a particular embodiment, the actuation means are an integral part of the main body of the electrical connector. Advantageously, this allows a reinforced configuration of both the main body and the actuation means, having a greater support in the structure thereof, integrated in the inner housing of the electrical connector.

In a particular embodiment, the actuation means are an independent element which is positioned in the inner housing of the main body of the electrical connector. This allows a better adaptability of the position of said actuation means, as well as a simpler maintenance, with it being possible to replace the actuation means if necessary.

A second inventive aspect of the present disclosure describes an electrical connection system comprising:
a drive belt, extending according to the longitudinal direction X-X′ and comprising a first end, a second end, and a plurality of metallic cables arranged according to the longitudinal direction X-X′ between the first end and the second end,
a first electrical connector according to the first inventive aspect, and
a second electrical connector according to the first inventive aspect, comprising electrical connection means,
   wherein the first end of the drive belt is inserted in the first connector and the second end of the belt is inserted in the second connector through the corresponding openings thereof, wherein the first electrical connector is longitudinally connected with the first end through the electrical connection of the plurality of metallic cables with the connection means of the first electrical connector according to the longitudinal direction X-X′,
   wherein the second connector is longitudinally connected with the second end through the electrical connection of the plurality of metallic cables with the connection means of the second electrical connector according to the longitudinal direction X-X′, and
   wherein the second electrical connector is configured for being connected in turn with at least one piece of external equipment.

The drive belt comprises metallic cables therein, arranged essentially parallel along the entire length thereof.

In a particular embodiment, the metallic cables are embedded in a plastic material, preferably a polymer material, extending along the outside of said metallic cables from the first end to the second end.

In a particular embodiment, the connection means comprise protrusions, wherein each protrusion directly contacts each of the metallic cables of the drive belt. In other words, at least one protrusion of the connection means is pressed into one of the metallic cables.

Advantageously, the present system allows the electrical connection of both connectors with the metallic cables of the drive belt in the longitudinal direction, allowing a direct and more efficient connection.

Moreover, the configuration of the present system and its electrical connectors located such that electrical connections are established according to the longitudinal direction X-X allows reducing the space required for assembling a connection having these characteristics, as well as a greater accessibility for maintenance and/or replacement operations both of any of the two connectors and of the drive belt of the system.

In a particular embodiment, at least one of the first electrical connector and the second electrical connector comprises fastening means configured for fixing the drive belt in a predetermined position when it is inserted through the opening. Advantageously, this allows the position of said drive belt to be fixed with respect to the inner housing of the main body of the connector.

In a particular embodiment, the fastening means are oriented according to the longitudinal direction X-X′.

In a particular embodiment, the fastening means are oriented according to a direction transverse to the longitudinal direction X-X′.

In a particular embodiment, the fastening means are selected from one of the following:
screwed and/or riveted attachments,
pins,
adhesive,
toe clamps, or
cams.

In a particular embodiment, at least one of the electrical connectors is configured in two parts, said electrical connector further comprising attachment means, preferably a screwed attachment, configured for attaching the parts of said electrical connector to one another.

In a particular embodiment, the attachment means are oriented according to the longitudinal direction X-X′.

In a particular embodiment, the attachment means are located on opposite faces of the perimeter of the main body of the electrical connector.

In a particular embodiment, the attachment means are configured for bringing the contact means of the electrical connector closer to the plurality of metallic cables of the drive belt through the actuation means according to the longitudinal direction X-X′.

Advantageously, this allows the electrical contact between the contact means and the plurality of metallic cables of the drive belt to be ensured, in turn fixing the relative position of said contact means with respect to each of the metallic cables of the drive belt. Additionally, the closeness of the contact means with the plurality of metallic cables of the drive belt allows a simpler assembly of the system.

In a particular embodiment, each protrusion of the contact means is electrically connected with a metallic cable of the drive belt.

In a particular embodiment, each protrusion of the contact means is electrically connected with at least two metallic cables of the drive belt. In a particular embodiment, said two or more metallic cables of the drive belt are correlative.

In a particular embodiment, the electrical connection means are connected, respectively, to the two corresponding ends of the contact means in a direction transverse to the longitudinal direction X-X′, preferably to the protrusions located at both ends of the contact means, as well as to the connection cables. Advantageously, this allows the space required for electrical connection with the at least one piece of external equipment to be reduced.

Additionally, the third and fourth inventive aspects relate to a method for assembling an electrical connection system such as the one referred to in the second inventive aspect, as well as a method for measuring the wear and/or breakage of a drive belt by means of an electrical connection system such as the one referred to in the second inventive aspect.

In particular, in a particular embodiment, an electrical connection system such as the one referred to in the second inventive aspect can be obtained from the following assembling sequence:
a) inserting the first end of the drive belt through the opening of the first electrical connector and the second end of the drive belt through the opening of the second electrical connector, and
b) connecting the contact means of the first and second electrical connectors, respectively, with the plurality of metallic cables of the drive belt.

Additionally, step a) may also comprise the action of fixing the position of the first and second ends of the drive belt to the respective electrical connector by attachment means, as indicated above.

In relation to the method for measuring the wear and/or breakage of a drive belt, and by means of an electrical connection system such as the one referred to in the second inventive aspect, an analysis of the conditions of said drive belt can be performed. To that end, in addition to an electrical connection system, it is also necessary to provide at least one piece of external equipment comprising a controller.

In this manner and according to a particular embodiment, said method for measuring the wear and/or breakage of at least one metallic cable of the drive belt can be performed according to the following sequence:
a) connecting the electrical connection system to the external equipment,
b) collecting, through the controller of the external equipment, data of the electrical connections existing between the contact means of the first and second electrical connectors, respectively, with the plurality of metallic cables of the drive belt, and
c) measuring the wear and/or breakage of at least one metallic cable of the drive belt through the data collected in step b).

The electrical connections of the protrusions of the contact means with the metallic cables of the drive belt therefore allow the state of said drive belt to be monitored through the controller of the external equipment.

In a particular embodiment, step a) is performed through the electrical connection of electrical connection means of at least one electrical connector to the external equipment.

Additionally, the present method for measuring the wear and/or breakage of at least one metallic cable of the drive belt further comprises an additional step, with this being a step d) of determining, based on the measurement performed in step c), the risk of the drive belt breaking, for the purpose of making suitable decisions in terms of the maintenance or repair of said drive belt. In a particular embodiment, step d) further comprises estimating the expected remaining service life of the drive belt based on the measurements performed in step c) and the previously determined risk of breaking.

### BRIEF DESCRIPTION OF THE DRAWINGS

To describe the disclosure and for the purpose of helping to make the features thereof more readily understandable, this specification is accompanied by a set of figures, which by way of illustration and not limitation represents the following:

FIG. 1A shows a perspective view of an exemplary embodiment of an electrical connector of the disclosure.

FIG. 1B shows an exploded view of the exemplary embodiment of the connector according to FIG. 1A.

FIG. 1C shows a perspective view of another exemplary embodiment of an electrical connector of the disclosure.

FIG. 1D shows an exploded view of the exemplary embodiment of the connector according to FIG. 1C.

FIG. 2A shows a perspective view of an exemplary embodiment of an electrical connection system of the disclosure.

FIG. 2B shows a perspective view of another exemplary embodiment of an electrical connection system of the disclosure.

FIG. 3A shows a side view of the exemplary embodiment of the electrical connection system according to FIG. 2B.

FIG. 3B shows a cross-section view of the drive belt present in FIG. 3A.

The features of particular embodiments of the present disclosure are described based on the present figures.

### DESCRIPTION OF THE INVENTION

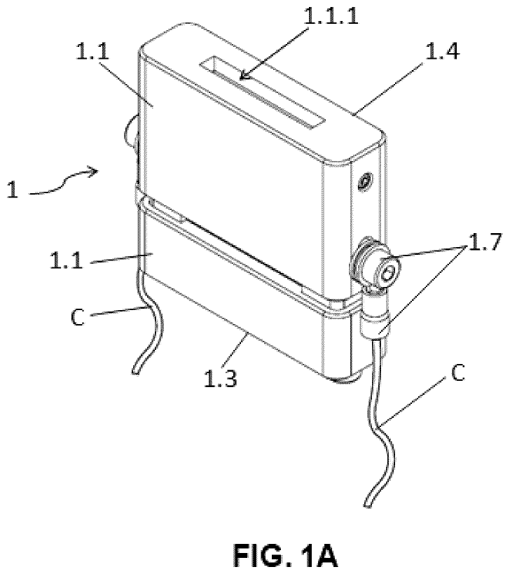

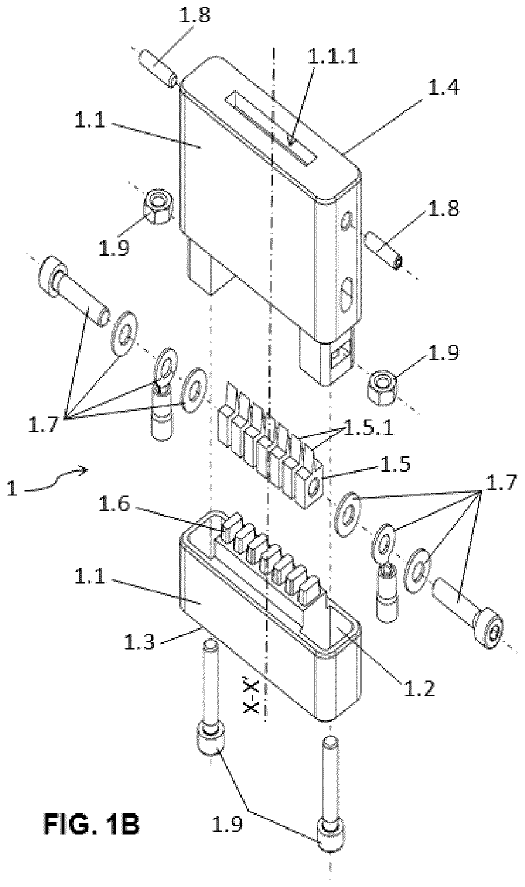

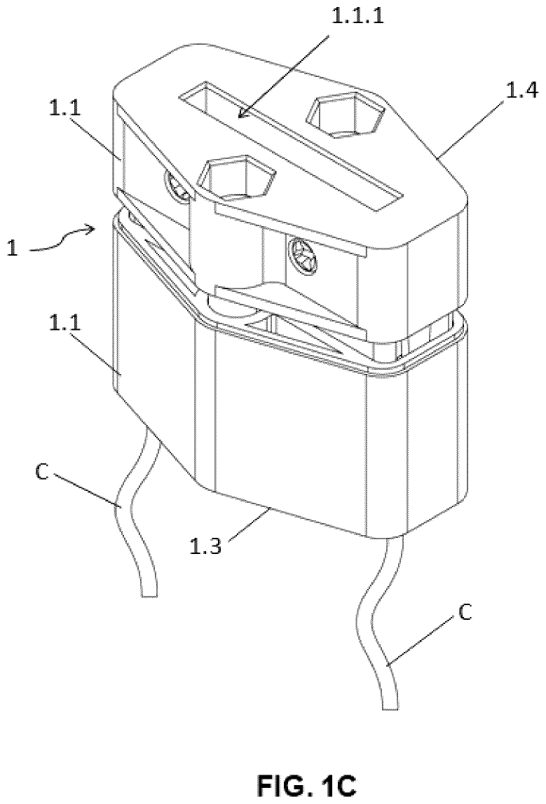

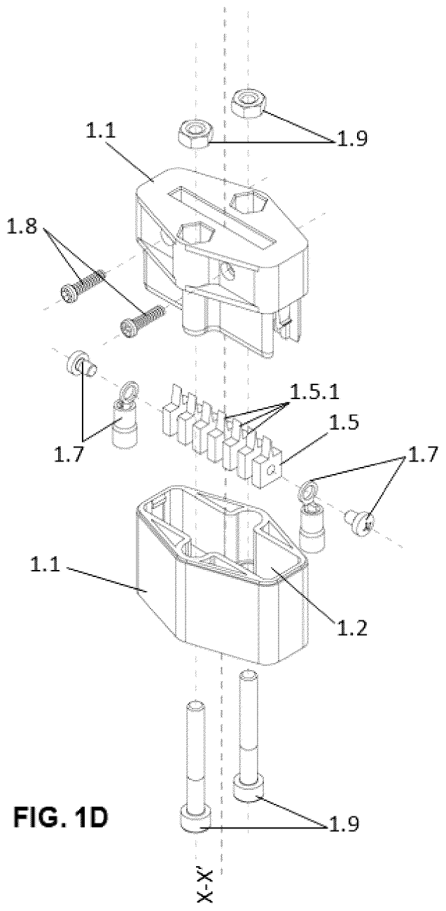

FIGS. 1A and 1B show an exemplary embodiment of an electrical connector (1) according to a first aspect of the disclosure, whereas FIGS. 1C and 1D show a second exemplary embodiment of an electrical connector (1) according to a first aspect of the disclosure.

As shown in said figures, the electrical connector (1) comprises a main body (1.1) which, in this case, is divided into two parts allowing them to be assembled and fixed to one another to form the main body (1.1) of said electrical connector (1). This main body (1.1), and therefore the electrical connector (1), extends according to a main direction, particularly a longitudinal direction X-X′.

The parts of the main body (1.1) are fixed to one another through attachment means (1.9), in this case said attachment means (1.9) being bolts, particularly anchoring screws, which extend longitudinally according to the longitudinal direction X-X′ and allow bringing the parts of the main body (1.1) closer in position and fixing them to one another. The attachment means (1.9) can also be through snap-fitting and/or a riveted attachment. In the case of FIGS. 1A and 1B, said attachment means (1.9) are located on two opposite faces of the perimeter of the main body (1.1), adjacent to the ends of the means of contact means (1.5). In the case of FIGS. 1C and 1D, said attachment means (1.9) are located on two opposite faces of the perimeter of the main body (1.1), in the direction transverse to the direction in which said contact means (1.5) extend.

Once its parts are assembled, the main body (1.1) comprises an inner housing (1.2), the main body (1.1) therefore being partially hollow.

According to FIG. 1A, the electrical connector (1) is limited by a first end (1.4) and a second end (1.3), each corresponding to the end of one of the parts of the main body (1.1). Additionally, one of the parts of the main body (1.1) comprises an opening (1.1.1), preferably a rectangular opening, for housing and fixing a drive belt (2.1). Said opening (1.1.1) is located at the second end (1.3) of the electrical connector (1), and allows accessing the inner housing (1.2) from the outside of the main body (1.1) of the electrical connector (1).

FIG. 1B shows said inner housing (1.2) in which actuation means (1.6) are in turn housed with the contact means (1.5) arranged thereon, said contact means (1.5) also being housed inside the inner housing (1.2) of the main body (1.1).

The contact means (1.5) in turn comprise a plurality of protrusions (1.5.1) oriented according to the longitudinal direction X-X′ towards the opening (1.1.1) located at the second end (1.4) of the main body (1.1).

When the electrical connector (1) is in use, said protrusions (1.5.1) allow electrical connection with metallic wires of a drive belt (2.1), thereby configuring an electrical circuit.

When the electrical connector (1) is in use, the actuation means (1.6) allow the position of the contact means (1.5), and therefore of the plurality of protrusions (1.5.1) in the longitudinal direction X-X′, to be modified and fixed, bringing said contact means (1.5) closer to the end of the drive belt (2.1) to cause electrical contact between the plurality of protrusions (1.5.1) and the metallic wires embedded in said drive belt (2.1), thereby configuring the electrical circuit.

In a particular embodiment, the electrical connector (1) comprises electrical connection means (1.7) which are connected to the contact means (1.5) at one end and to the external equipment (E) at the opposite end through at least one connection cable (C), as shown in FIG. 1A.

The electrical connection means (1.7) therefore allow electrical connection of the contact means (1.5) with the external equipment (E) which allows the measurement of electrical data, in this case electrical data collected by the plurality of protrusions (1.5.1) when they are in contact with the metallic wires of the drive belt (2.1).

As shown in FIG. 1A, the electrical connection means (1.7) are configured by means of a part which allows the housing and electrical connection of an end of a metallic connection cable (C) with the contact means (1.5) that are also metallic. Said part which houses and connects the end of the connection cable (C) is fixed to the contact means (1.5) through attachment means, such as screws or pins, allowing all the parts of said electrical connection means (1.7) to electrically contact the contact means (1.5).

Additionally, the electrical connector (1) comprises in its main body (1.1) housings for fastening means (1.8) of the drive belt (2.1) when the electrical connector (1) is in use.

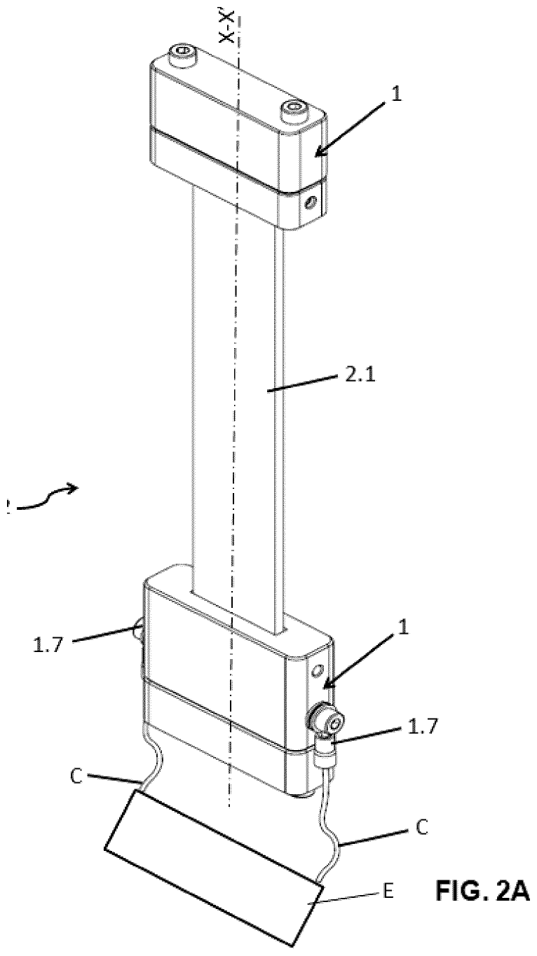

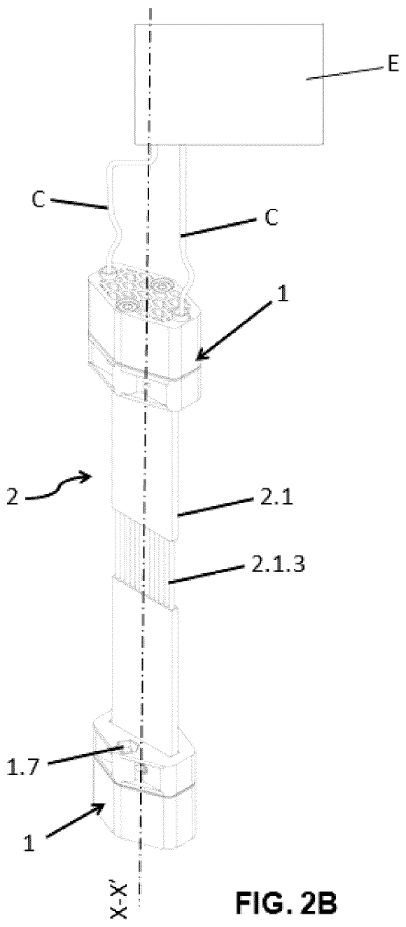

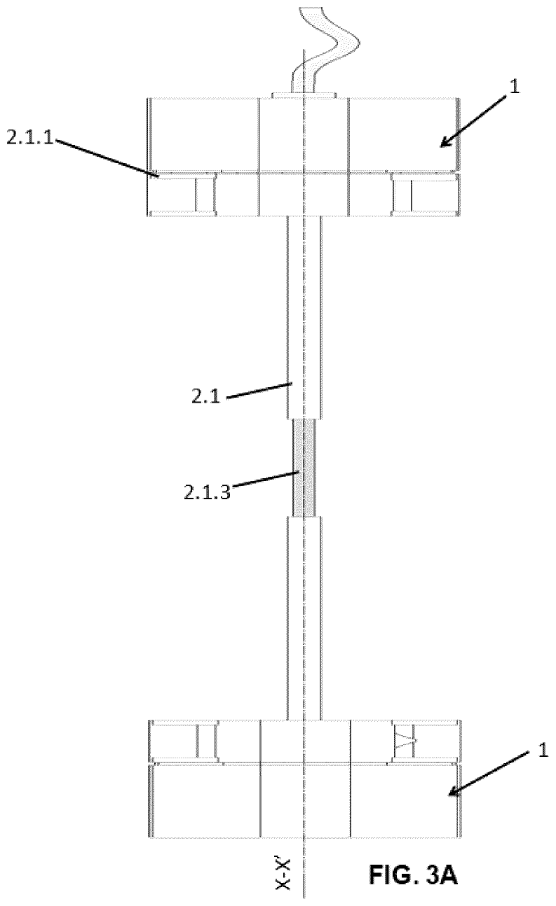

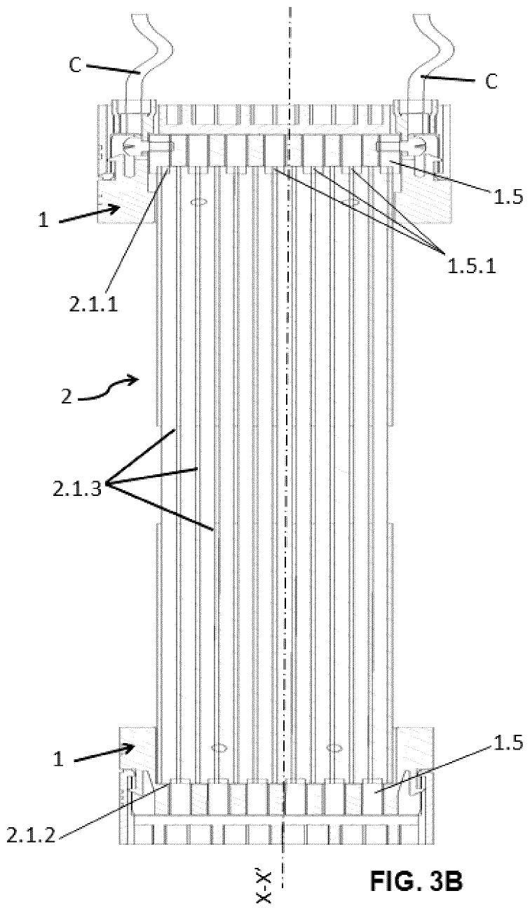

A second aspect of the present disclosure relates to an electrical connection system (2) of which a particular embodiment is shown in FIGS. 2A, 2B, 3A, and 3B.

In particular, FIG. 2A shows an electrical connection system (2) configured by a first electrical connector (1) and a second electrical connector (1). FIG. 2B shows a second example of an electrical connection system (2).

In this case, as can be seen, the second electrical connector (1) comprises electrical connection means (1.7) whereas the first electrical connector (1) does not have said electrical connection means (1.7). The second electrical connector (1) can therefore be connected, through said electrical connection means (1.7), with one or more pieces of external equipment, through one or more connection cables (C).

In particular, the electrical connection means (1.7) are connected, respectively, to the protrusions (1.5.1) located at the two corresponding ends of the contact means (1.5), i.e., to the protrusions located at both ends of the contact means (1.5), as well as to the connection cables (C) which are in turn connected with the corresponding external equipment (E).

The electrical connection system (2) also comprises a drive belt (2.1) extending in the longitudinal direction X-X′. The drive belt (2.1) comprises a first end (2.1.1) and a second end (2.1.2) which are fixed, respectively, to the first and second electrical connectors (1). In particular, as shown in the cross-section of FIG. 3A, the first end (2.1.1) and the second end (2.1.2) are introduced through the opening (1.1.1) of the first and second electrical connectors (1), respectively, said first end (2.1.1) and said second end (2.1.2) of the drive belt (2.1) therefore being housed in the inner housing (1.2) of the first and second electrical connectors (1). In the technical field of lifts/elevators, said first end (2.1.1) and said second end (2.1.2) of the drive belt (2.1) are called ends (A) and (B) of the drive belt, with the end (A) corresponding with the end associated with the first connector (1), comprising electrical connection means (1.7), and the end (B) corresponding with the end associated with the second connector (1).

In particular, as shown in FIGS. 2A and 2B, as well as in FIGS. 3A and 3B, the drive belt (2.1) is fitted in the first and second electrical connectors (1) through said opening (1.1.1), with the position thereof being fixed by fastening means (1.8).

The fastening means (1.8) of FIG. 1B are set screws which cooperate with through openings made on the main body (1.1) of the electrical connector (1), and are oriented perpendicular to the direction in which the contact means (1.5) extend.

The fastening means (1.8) of FIG. 1D are through screws oriented in the direction transverse to the direction in which the contact means (1.5) extend.

The position in which the drive belt (2.1) is kept fixed is a predetermined position, with it being a position close to the first end (2.1.1) or the second end (2.1.2), as appropriate with respect to the first and second electrical connectors (1).

FIG. 3B shows a section view of the first end (2.1.1) and the second end (2.1.2) of the drive belt (2.1), a plurality of metallic cables (2.1.3) in the form of metallic wires, extending along the longitudinal direction X-X, embedded in the drive belt (2.1), is observed. This case shows how said metallic cables (2.1.3) are uniformly distributed along the section of the drive belt (2.1), with each of the metallic cables (2.1.3) being a bundle of metallic wires.

FIGS. 3A and 3B show the assembly of the electrical connection system (2) once the drive belt (2.1) has been introduced in the first and second electrical connectors (1) and the position of said connectors has been fixed.

This case shows how the plurality of protrusions (1.5.1) contact the metallic cables (2.1.3) of the drive belt (2.1) in the longitudinal direction X-X′.

The contact means (1.5) of the first electrical connector (1) thereby electrically contact the metallic cables (2.1.3) from the first end (2.1.1) of the drive belt (2.1), whereas the contact means (1.5) of the second electrical connector (1) electrically contact the metallic cables (2.1.3) from the second end (2.1.2) of the drive belt (2.1).

This electrical contact in the longitudinal direction allows better access to the metallic cables (2.1.3) of the drive belt (2.1) from the first end (2.1.1) and the second end (2.1.2) of the drive belt (2.1), in addition to providing a simpler configuration. Likewise, this configuration of electrical connection is also more secure, given that the protrusions (1.5.1) of the contact means (1.5) are housed inside each electrical connector (1), without being exposed or having to be embedded in the material forming the drive belt (2.1), the contact between the protrusions (1.5.1) and the metallic cables (2.1.3) therefore being more direct and homogeneous.

Additionally, the actuation means (1.6) allow moving the contact means (1.5) in the longitudinal direction X-X′, such that the protrusions (1.5.1) of said contact means (1.5) are brought closer, by means of the actuation means (1.6), to the metallic cables (2.1.3) of the first end (2.1.1) or the second end (2.1.1) of the drive belt (2.1), accordingly.

These electrical connections can be made based on different configurations. In the simplest exemplary embodiment, the connection of the two end protrusions (1.5.1) of the contact means (1.5) with the end metallic cables (2.1.3) of the drive belt (2.1), as well as the electrical connection of an intermediate protrusion (1.5.1) with an intermediate metallic cable (2.1.3) of the drive belt (2.1), are made both in the first connector (1) and in the second connector (1).

In another exemplary embodiment, each protrusion (1.5.1) of the contact means (1.5) is electrically connected with a single metallic cable (2.1.3) of the drive belt (2.1), with all the protrusions (1.5.1) therefore being electrically connected with a single metallic cable (2.1.3) of those available in the drive belt or vice versa, and with all the metallic cables (2.1.3) of the drive belt being electrically connected with a single protrusion (1.5.1) of the plurality available in the contact means.

In another exemplary embodiment, each protrusion (1.5.1) of the contact means (1.5) is electrically connected with two correlative metallic cables (2.1.3) of the drive belt (2.1). In other words, each protrusion (1.5.1.) is connected with two adjacent metallic cables (2.1.3), without one and the same metallic cable (2.1.3) being connected with more than one protrusion (1.5.1). Each pair of metallic cables (2.1.3) is therefore a connection diagram between metallic wires which allow short-circuiting each of said pairs in the electrical circuit.

Any of these configurations provides a closed electrical circuit, wherein the drive belt (2.1) is connected to external equipment (E) for measuring various parameters, preferably wear and/or breakage, through the second connector (1), whereas the first connector (1) allow closing said electrical circuit with the connection thereof to the opposite end of the drive belt (2.1).

1-20. (canceled)

21. An electrical connection system comprising:
a drive belt, extending according to a longitudinal direction X-X′ and comprising a first end, a second end, and a plurality of metallic cables arranged according to the longitudinal direction X-X′ between the first end and the second end,
a first electrical connector, and
a second electrical connector,
wherein the first electrical connector and the second electrical connector comprise:
a main body extending according to the longitudinal direction X-X′, wherein the main body comprises:
an inner housing,
a first end, and
a second end comprising an opening which allows accessing the inner housing,
contact means housed in the inner housing, oriented according to the longitudinal direction X-X′ towards the second end, the contact means comprising a plurality of protrusions,
wherein the second electrical connector further comprises electrical connection means connected to the contact means, said electrical connection means being configured for connecting the contact means with at least one piece of external equipment, preferably by means of at least one connection cable,
wherein the first end of the drive belt is inserted in the first connector and the second end of the belt is inserted in the second connector through the corresponding openings thereof,
wherein the first electrical connector is longitudinally connected with the first end of the drive belt through the electrical connection of the plurality of metallic cables with the connection means of the first electrical connector according to the longitudinal direction X-X′,
wherein the second connector is longitudinally connected with the second end of the drive belt through the electrical connection of the plurality of metallic cables with the connection means of the second electrical connector according to the longitudinal direction X-X′, and
wherein each protrusion of the contact means both of the first electrical connector and the second electrical connector is electrically connected with at least two adjacent metallic cables of the drive belt.

22. The electrical connection system according to claim 21, wherein at least one of the first electrical connector and the second electrical connector comprises fastening means configured for fixing the drive belt in a predetermined position when it is inserted through the opening.

23. The electrical connection system according to claim 22, wherein the fastening means are selected from one of the following:
screwed and/or riveted attachments,
pins,
adhesive,
toe clamps, or
cams.

24. The electrical connection system according to claim 21, wherein at least one of the first electrical connector or the second electrical connector further comprises actuation means configured for actuating the contact means, said actuation means being housed in the inner housing and oriented according to the longitudinal direction X-X′.

25. The electrical connection system according to claim 21, wherein the main body of at least one of the first electrical connector or the second electrical connector is configured by at least two parts, said at least two parts being attached to one another, preferably by means of snap-fitting and/or a screwed attachment and/or a riveted attachment.

26. The electrical connection system according to claim 25, wherein at least one of the of the first electrical connector and the second electrical connector further comprises attachment means, preferably a screwed attachment, configured for attaching the parts of said electrical connector to one another.

27. The electrical connection system according to claim 26, wherein the attachment means are configured for bringing the contact means of the at least one of the of the first electrical connector and the second electrical connector closer to the plurality of metallic cables of the drive belt through the actuation means according to the longitudinal direction X-X′.

28. The electrical connection system according to claim 21, wherein the electrical connection means are connected, respectively, to the protrusions located at the two corresponding ends of the contact means, as well as to the connection cables.

29. A method for assembling an electrical connection system according to claim 21, comprising:
a) inserting the first end of the drive belt through the opening of the first electrical connector and the second end of the drive belt through the opening of the second electrical connector, and
b) connecting the contact means of the first and second electrical connectors, respectively, with the plurality of metallic cables of the drive belt.

30. The method for assembling an electrical connection system according to claim 29, wherein step a) further comprises fixing the position of the first and second ends of the drive belt to the respective electrical connector by attachment means.

31. A method for measuring the wear and/or breakage of at least one metallic cable of a drive belt by means of an electrical connection system according to claim 21 and at least one piece of external equipment comprising a controller, comprising:
a) connecting the electrical connection system to the external equipment,
b) collecting, through the controller of the external equipment, data of the electrical connections existing between the contact means of the first and second electrical connectors, respectively, with the plurality of metallic cables of the drive belt, and
c) measuring the wear and/or breakage of at least one metallic cable of the drive belt through the data collected in step b).

32. The method for measuring the wear and/or breakage of at least one metallic cable of a drive belt according to claim 31, wherein step a) is performed through the electrical connection of electrical connection means of at least one electrical connector to the external equipment.

33. The method for measuring the wear and/or breakage of at least one metallic cable of a drive belt according to claim 31, further comprising the step of:
d) determining, based on the measurement performed in step c), the risk of the drive belt breaking.

34. The method for measuring the wear and/or breakage of at least one metallic cable of a drive belt according to claim 33, wherein step d) further comprises estimating the expected remaining service life of the drive belt.
